(19) United States
(12) Patent Application Publication
(10) Pub. No.: US 2015/0365474 A1
(43) Pub. Date: Dec. 17, 2015

(54) COMPUTER-READABLE RECORDING MEDIUM, TASK ASSIGNMENT METHOD, AND TASK ASSIGNMENT APPARATUS

(71) Applicant: FUJITSU LIMITED, Kawasaki-shi (JP)

(72) Inventor: Yuichi MATSUDA, Yokohama (JP)

(73) Assignee: Fujitsu Limited, Kawasaki (JP)

(21) Appl. No.: 14/724,991

(22) Filed: May 29, 2015

(30) Foreign Application Priority Data
Jun. 13, 2014 (JP) 2014-122815

(51) Int. Cl. H04L 29/08; G06F 17/30

(52) U.S. Cl. CPC H04L 67/104; G06F 17/30864

(57) ABSTRACT

A task assignment apparatus executes a process of distributing pieces of divided data contained in a first divided data group, which is obtained by dividing input data, to a plurality of nodes that execute Map processes. The task assignment apparatus, upon completion of Map processes of partial divided groups in the first divided data group, estimates a data amount of each piece of distributed data by applying, to results of the Map processes of the partial divided data groups, a generation rule for generating pieces of the distributed data for a plurality of nodes that execute Reduce processes. The task assignment apparatus starts to control selection of nodes, to which at least some pieces of the distributed data are assigned, on the basis of the estimated data amounts before of all of the Map processes on the first divided data group complete.

### CROSS-REFERENCE TO RELATED APPLICATION

This application is based upon and claims the benefit of priority of the prior Japanese Patent Application No. 2014-122815, filed on Jun. 13, 2014, the entire contents of which are incorporated herein by reference.

### FIELD

The embodiments discussed herein are related to a task assignment program, a task assignment method, and a task assignment apparatus.

### BACKGROUND

With the popularization of cloud computing, a distributed processing system has been used, which causes a plurality of servers to perform distributed processing on a large amount of data stored in clouds. As the distributed processing system, Hadoop (registered trademark) has been known, which uses a Hadoop distributed file system (HDFS) and MapReduce processing as base technologies.

The HDFS is a file system that stores data in a plurality of servers in a distributed manner. MapReduce is a framework that executes distributed processing on data on the HDFS in a certain unit called a task, and performs a Map process, a Shuffle and Sort process, and a Reduce process.

In the distributed processing based on MapReduce, a master server assigns tasks of the Map process and the Reduce process to a plurality of slave servers by using a hash function or the like, and transmits divided data to each of the slave servers. Then, each of the slave servers performs the assigned tasks.

The tasks are equally assigned to the slave servers by using a hash function or the like. However, the amount of processing corresponding to each Reduce task is not always uniform because of, for example, the amount of data to be subjected to Reduce associated with a key or the like corresponding to a Reduce task.

For example, a plurality of sort keys may be concentrated in a single slave server depending on the type of a hash function or the like. Further, even if the sort keys are equally sorted into each of the slave servers, the amount of processing varies for each Reduce task. Therefore, a process completion time of each of the slave servers varies, so that completion of the entire job including a plurality of tasks depends on completion of processes in a slave server that performs the processes most slowly. Therefore, there is a known technology that adjusts the amount of data such that the amount of processing corresponding to each Reduce task is equalized after all of the Reduce tasks are assigned to the slave servers.
Patent Literature 1: Japanese Laid-open Patent Publication No. 2012-118669
Patent Literature 2: Japanese Laid-open Patent Publication No. 2010-244469
Patent Literature 3: Japanese Laid-open Patent Publication No. 2007-264794
Patent Literature 4: Japanese Laid-open Patent Publication No. 2013-69189
Patent Literature 5: Japanese Laid-open Patent Publication No. 2010-218307

However, the inequality of the amount of processing of each Reduce task depends on various influences, such as input data or results of Map processes; therefore, execution of the adjustment process as in the technology as described above does not always speed up the completion time of the entire job.

For example, to adjust the amount of processing of a Reduce task, the adjustment is performed after all Map processes complete; therefore, the start of a Reduce process performed by each of the slave servers may be delayed and processing time of the entire job may be increased.

### SUMMARY

According to an aspect of the embodiments, non-transitory computer-readable recording medium stores therein a task assignment program that causes a computer to execute a process. The process includes: distributing pieces of divided data contained in a first divided data group, which is obtained by dividing input data, to a plurality of nodes that execute Map processes; estimating, upon completion of Map processes of partial divided data groups in the first divided data group, a data amount of each piece of distributed data by applying, to results of the Map processes of the partial divided data groups, a generation rule for generating pieces of the distributed data for a plurality of nodes that execute Reduce processes which are executed after completion of all of Map processes on the first divided data group; and starting to control selection of nodes, to which at least some pieces of the distributed data are assigned, on the basis of the estimated data amounts before completion of all of the Map processes on the first divided data group.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating an example of the overall configuration of a distributed processing system according to a first embodiment;

FIG. 2 is a functional block diagram illustrating a functional configuration of a master server according to a second embodiment;

FIG. 3 is a diagram illustrating an example of information stored in a job list DB;

FIG. 4 is a diagram illustrating an example of information stored in a task list DB;

FIG. 5 is a diagram illustrating an example of information stored in a cluster profile DB;

FIG. 6 is a diagram illustrating an example of a completion notice of a Map process;

FIG. 7 is a functional block diagram illustrating a functional configuration of a slave server according to the second embodiment;

FIG. 8 is a diagram for explaining the Map process;

FIG. 9 is a diagram for explaining a Shuffle process;

FIG. 10 is a diagram for explaining a Reduce process;

FIG. 11 is a diagram for explaining change in assignment of the Reduce process;

FIG. 12 is a flowchart illustrating the flow of a process performed by the master server according to the second embodiment;

FIG. 13 is a flowchart illustrating the flow of a process performed by the slave server according to the second embodiment;

FIG. 14 is a diagram for explaining a relationship between a task progress image and a threshold; and

FIG. 15 is a diagram illustrating an example of a hardware configuration of a server.

### DESCRIPTION OF EMBODIMENTS

Preferred embodiments will be explained with reference to accompanying drawings. The present invention is not limited to the embodiments below. The embodiments may be combined appropriately as long as the combination does not cause any contradiction.

### [a] First Embodiment

### Overall Configuration

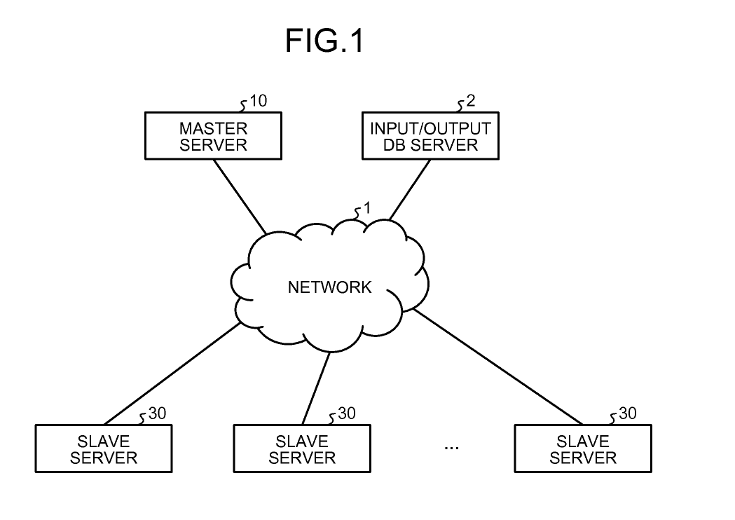

FIG. 1 is a diagram illustrating an example of the overall configuration of a distributed processing system according to a first embodiment. As illustrated in FIG. 1, the distributed processing system includes an input/output database (DB) server 2, a master server 10, and a plurality of slave servers 30, which are communicably connected to one another via a network 1.

In the distributed processing system, each computing machine executes a distributed processing application using a distributed processing framework, such as a Hadoop (registered trademark), and uses an HDFS as a data base.

The input/output DB server 2 is a database server that stores therein meta-information or the like on data as an object of distributed processing. For example, the meta-information stored in the input/output DB server 2 is used to specify which data is stored in which of the slave servers 30.

The master server 10 is a server that centrally manages the distributed processing system. For example, the master server 10 specifies which data is stored in which of the slave servers 30, from the meta-information stored in the input/output DB server 2. Further, the master server 10 manages a task, a job, or the like to be assigned to each of the slave servers 30, and assigns tasks, such as Map processes and Reduce processes, to the slave servers 30. Incidentally, the master server 10 is an example of the task assignment apparatus.

Each of the slave servers 30 is a server that implements a distributed processing application, and performs the Map process and the Reduce process to perform distributed processing on data managed by the HDFS. For example, the slave server 30 includes a plurality of processors and a plurality of disks. Further, an identifier for unique identification is assigned to each of the slave servers 30. Incidentally, the slave server 30 is an example of a node.

The slave server 30 performs a task of the Map process assigned by the master server 10 on data acquired from the input/output DB server 2. Further, the slave server 30 performs a Shuffle and Sort process by using a result of the Map process performed by each of the slave servers, and performs a task of the Reduce process assigned by the master server 10.

Each process will be described below. The Map process is a process of executing a Map function defined by a user. For example, the Map process outputs “Key, Value” pairs as intermediate results from input data. The Shuffle and Sort process sorts the results of the Map processes by “Key”, and merges “Key, Value” pairs containing the same “Key”. The Reduce process is a process of executing a Reduce function defined by the user. For example, the Reduce process performs a superposing process on “Value” with the same “Key” from the results of the Shuffle and Sort process, and generates “Key, Value” pairs in a new format.

In this condition, the master server 10 distributes pieces of divided data contained in a first divided data group, which is obtained by dividing the input data, to the slave servers 30 that perform the Map processes. Then, upon completion of the Map processes on partial divided data groups in the first divided data group, the master server 10 applies, to the results of the Map processes on the partial divided data groups, a rule for generating pieces of distributed data for a plurality of nodes that perform Reduce processes which are executed after completion of all of the Map processes on the first divided data group, and estimates a data amount of each piece of the distributed data. Thereafter, the master server 10 starts to control selection of nodes to which at least some pieces of the distributed data are assigned, on the basis of the estimated data amount before completion of all of the Map processes on the first divided data group.

For example, the master server 10, upon starting to perform distributed processing using MapReduce, assigns a task of the Map process to each of the slave servers 30 by using a hash function or the like of a sort key specified in advance. Subsequently, the master server 10 assigns a task of the Reduce process to each of the slave servers 30 by using a hash function or the like of a sort key specified in advance.

At this time, the master server 10 controls assignment of the tasks of the Reduce processes. The master server 10, upon completion of a predetermined number of the Map processes, estimates an amount of processing of a Reduce task by using the results of the Map processes. Then, the master server 10 starts to assign the tasks of the Reduce processes such that a task with a large amount of processing is assigned to the slave server 30 with high specifications.

As a result, the master server 10 can assign a task with a large amount of processing to the slave server 30 with high specifications, and can equalize the processing time of each of the Reduce processes. Therefore, the master server 10 can prevent a large delay in completion of the Reduce processes, and can reduce the completion time of the entire job.

### [b] Second Embodiment

In the first embodiment, an example has been described, in which assignment of tasks of the Reduce processes are first controlled, the amounts of the Reduce processes are subsequently estimated based on the Map processes, and then the Reduce processes are assigned in accordance with a result of the estimation; however, the present invention is not limited thereto.

In general, in the distributed processing using MapReduce, when a process starts upon input of data, the Map processes and the Reduce processes are automatically assigned by a hash function. Even in this case, the master server 10 according to a second embodiment can reassigns the Reduce processes. Therefore, in the second embodiment, reassignment of the Reduce processes will be described. Incidentally, the overall configuration is the same as illustrated in FIG. 1.

Configuration of Master Server

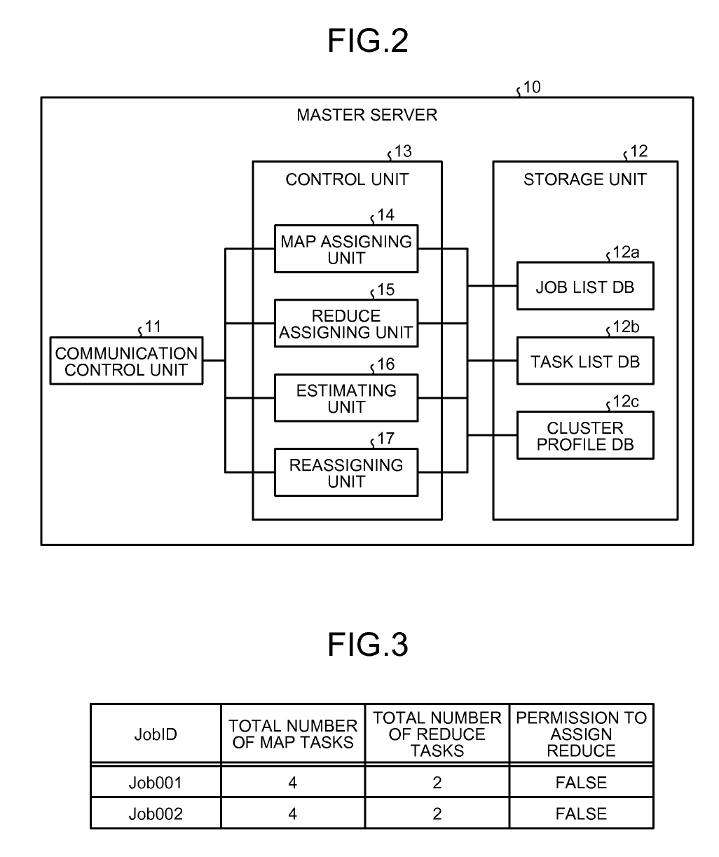

FIG. 2 is a functional block diagram illustrating a functional configuration of a master server according to the second embodiment. As illustrated in FIG. 2, the master server 10 includes a communication control unit 11, a storage unit 12, and a control unit 13.

The communication control unit 11 is a processing unit that performs communication with other devices, such as the slave servers 30, and is, for example, a network interface card or the like. For example, the communication control unit 11 transmits a Map process task or a Reduce process task to each of the slave servers 30. Further, the communication control unit 11 receives a Map process result or the like from each of the slave servers 30.

The storage unit 12 is a storage device that stores therein a job list DB 12a, a task list DB 12b, and a cluster profile DB 12c, and is, for example, a memory, a hard disk, or the like. Further, the storage unit 12 stores therein a computer program or the like to be executed by the control unit 13.

The job list DB 12a is a database for storing information on a job as an object of distributed processing. FIG. 3 is a diagram illustrating an example of information stored in the job list DB 12a. As illustrated in FIG. 3, the job list DB 12a stores therein “a JobID, a total number of Map tasks, a total number of Reduce tasks, and a permission to assign Reduce” in an associated manner.

The “JobID” stored in this example is an identifier for identifying a job. The “total number of Map tasks” is the total number of Map process tasks contained in the job. The “total number of Reduce tasks” is the total number of Reduce process tasks contained in the job. The “permission to assign Reduce” indicates whether a Reduce process task is assignable, and, is set to “true” if assignment is possible, set to “false” if assignment is not possible, and set to “false” if a new job is added. Incidentally, “the JobID, the total number of Map tasks, and the total number of Reduce tasks” are set and updated by an administrator or the like.

In the example in FIG. 3, it is indicated that a job with the “JobID” of “Job001” includes four Map process tasks and two Reduce process tasks and assignment to the job is not currently possible. Similarly, it is indicated that a job with the “JobID” of “Job002” includes four Map process tasks and two Reduce process tasks and assignment to the job is not currently possible.

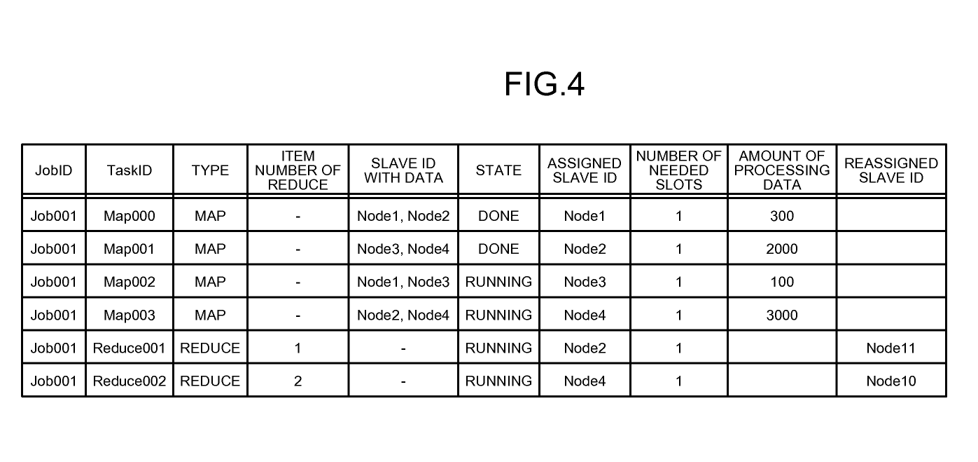

The task list DB 12b is a database for storing information on a Map process task and a Reduce process task. FIG. 4 is a diagram illustrating an example of information stored in the task list DB 12b. As illustrated in FIG. 4, the task list DB 12b stores therein “a JobID, a TaskID, a type, an item number of Reduce, a slave ID with data, a state, an assigned slave ID, the number of needed slots, an amount of processing data, and a reassigned slave ID”.

The “JobID” stored in this example is an identifier for identifying a job. The “TaskID” is an identifier for identifying a task. The “type” is information indicating a Map process or a Reduce process. The “slave ID with data” is an identifier for identifying the slave server 30 that stores therein data as an object of a Map process, and is, for example, a host name or the like. The “state” indicates whether a corresponding task is in a process completed state (Done), is being processed (Running), or is not yet assigned (Not assigned). The “item number of Reduce” indicates the order in which a corresponding Reduce is executed.

The “assigned slave ID” is an identifier for identifying the slave server 30 to which a task is assigned by using a hash function, and is, for example, a host name or the like. The “number of needed slots” is the number of slots to be used to perform a task. The “amount of processing data (a unit is GB)” is the amount of data of a corresponding Reduce process task. The “reassigned slave ID” is an identifier for identifying the slave server 30 to which a Reduce process task once assigned by using a hash function is reassigned.

In FIG. 4, in a job with the “JobID” of “Job001”, a Map process task of “Map000” using a single slot is assigned to the slave server 30 of “Node1”. It is indicated that the slave server 30 of “Node1” has acquired data from the slave server 30 of “Node1” and the slave server 30 of “Node2”, performed the Map process, and completed the Map process. It is also indicated that the amount of processing data of the Map process task of “Map000” is 300 GB.

Further, in the job with the “JobID” of “Job001”, a Reduce process task of “Reduce002”, which is performed second by using a single slot, is assigned to the slave server 30 of “Node4” by a hash function. However, it is indicated that the Reduce process task of “Reduce002” is reassigned to the slave server 30 of “Node10” at a later time.

The JobID, the TaskID, the type, and the item number of Reduce are generated in accordance with the information stored in the job list DB 12a. The slave ID with data can be identified by the meta-information or the like stored in the input/output DB server 2. The state is updated in accordance with a task assignment state, processing results from the slave server 30, or the like. The assigned slave ID is updated when a task is assigned. The number of needed slots can be specified in advance such that a single slot is used for a single task. The amount of processing data of a Reduce process can be estimated from a completed result of a Map process.

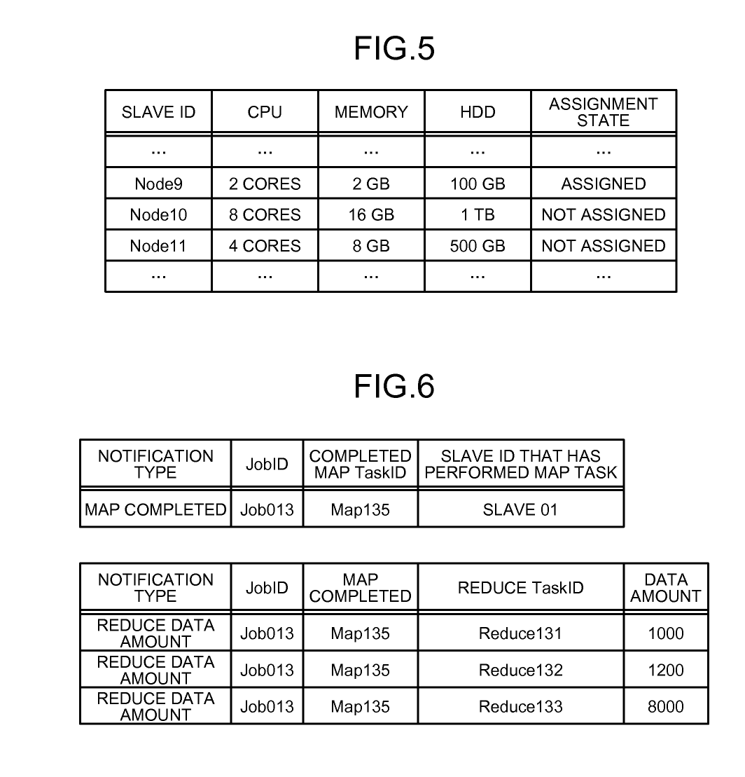

The cluster profile DB 12c is a database for storing specifications of each of the slave servers. FIG. 5 is a diagram illustrating an example of information stored in the cluster profile DB 12c. As illustrated in FIG. 5, the cluster profile DB 12c stores therein “a slave ID, a CPU, a memory, an HDD, and an assignment state”. Incidentally, “the slave ID, the CPU, the memory, and the HDD” are values set by an administrator or the like, and “the assignment state” is information updated by the control unit 13.

The “slave ID” stored in this example is an identifier for uniquely identifying the slave server 30. The “CPU” indicates the number of processors included in the slave server 30. The “memory” indicates a capacity of a memory included in the slave server 30. The “HDD” indicates a capacity of a hard disk included in the slave server 30. The “assignment state” is information indicating whether a Reduce process task is already assigned, and, is set to “Not assigned” before assignment and set to “assigned” after assignment.

In FIG. 5, it is indicated that the slave server 30 of “Node9” includes a processor with two cores, a memory with the capacity of 2 GB, and an HDD with the capacity of 100 GB, and is assigned with a Reduce process task. Further, it is indicated that the slave server 30 of “Node10” includes a processor with eight cores, a memory with the capacity of 16 GB, and an HDD with the capacity of 1 TB, and is not yet assigned with a Reduce process task.

The control unit 13 is a processing unit that controls the entire processing of the master server 10, and includes a Map assigning unit 14, a Reduce assigning unit 15, an estimating unit 16, and a reassigning unit 17. The control unit 13 is an electronic circuit, such as a processor, and the Map assigning unit 14, the Reduce assigning unit 15, the estimating unit 16, and the reassigning unit 17 are examples of electronic circuits or examples of processes executed by the control unit 13.

The Map assigning unit 14 is a processing unit that assigns a Map process task, which is a task of a Map process in each job, to at least one of the slave servers 30 by using a hash function or the like of a sort key specified in advance. The Map assigning unit 14 updates the “assigned slave ID”, the “state”, and the like illustrated in FIG. 4.

As one example, the Map assigning unit 14, upon receiving an assignment request to assign a Map process task from the slave server 30 or the like, specifies Map process tasks corresponding to the “state” of “Not assigned” by referring to the task list DB 12b. Subsequently, if there is a Map process task whose “slave ID with data” contains an ID of the slave server 30 that has transmitted the assignment request, the Map assigning unit 14 preferentially selects this Map process task. If there is no Map process task as described above, the Map assigning unit 14 selects a Map process task by an arbitrary method, and employs the selected task as a Map process task to be assigned. Thereafter, the Map assigning unit 14 stores the ID of the slave server 30 that has transmitted the assignment request in the “assigned slave ID” of the Map process task to be assigned.

Thereafter, the Map assigning unit 14 assigns the Map process task to the slave server 30 of an assignment destination, by notifying the slave server 30 of the TaskID, the slave ID with data, the number of needed slots, and the like. Further, the Map assigning unit 14 updates the “state” of the assigned Map process task from “Not assigned” to “Running”.

The Reduce assigning unit 15 assigns a Reduce process task, which is a task of a Reduce process in each job, to at least one of the slave servers 30 by using a hash function or the like of a sort key specified in advance.

For example, the Reduce assigning unit 15, upon receiving an assignment request to assign a Reduce process task from the slave server 30 or the like, specifies Reduce process tasks with the “state” of “Not assigned” by referring to the task list DB 12b. Subsequently, the Reduce assigning unit 15 specifies a slave server serving as an assignment destination, by using a hash function or the like. Thereafter, the Reduce assigning unit 15 stores the ID of the slave server 30 specified as the assignment destination in the “assigned slave ID” of a Reduce process to be assigned. Further, the Reduce assigning unit 15 updates the assignment state of the slave server 30 serving as the assignment destination from “Not assigned” to “assigned” in the cluster profile DB 12c.

Thereafter, the Reduce assigning unit 15 assigns the Reduce process task to the slave server 30 specified as the assignment destination, by notifying the slave server 30 of the TaskID, the number of needed slots, the amount of processing data, a flag, and the like. Further, the Reduce assigning unit 15 updates the “state” of the assigned Reduce process task from “Not assigned” to “Running”. Incidentally, the Reduce assigning unit 15, upon receiving a completion notice of the Reduce process task, updates the “state” of a corresponding Reduce process task from “Running” to “Done”.

The estimating unit 16 is a processing unit that estimates a Reduce process with a large amount of processing data, from processing results of some of the Map process tasks. Specifically, the estimating unit 16, upon completion of a predetermined number of Map process tasks among all of the Map process tasks, estimates a Reduce process with a large amount of processing data based on the amount of processing data of a completed Map process task or based on an amount of data of a Reduce process obtained from the amount of processing data of the Map process.

For example, the estimating unit 16 acquires an amount of data of a Map process from a completion notice of the Map process given by the slave server 30. Then, the estimating unit 16 specifies a Map process whose amount of processing data exceeds a predetermined amount, and specifies a Reduce process using the specified Map process by referring to the job list DB 12a, the task list DB 12b, or the like. Thereafter, the estimating unit 16 notifies the reassigning unit 17 of the specified Reduce process as a Reduce process whose amount of processing exceeds a threshold.

In the example in FIG. 4, the estimating unit 16 specifies “Map001” and “Map003” as Map process tasks whose amounts of processing data are equal to or greater than the threshold (1000). Thereafter, the estimating unit 16 specifies Reduce process tasks of “Reduce001” and “Reduce002” associated with the same JobID of “Job001” as that associated with the Map process tasks of “Map001” and “Map003”. Then, the estimating unit 16 notifies the reassigning unit 17 of the Reduce process tasks of “Reduce001” and “Reduce002” as the Reduce process tasks whose amounts of processing exceed the threshold.

For another example, the estimating unit 16 may estimate the amount of data of a Reduce process from a processing result of a Map process. FIG. 6 is a diagram illustrating an example of a completion notice of a Map process. The completion notice illustrated in FIG. 6 is transmitted by each of the slave servers 30 to the master server 10. As illustrated in FIG. 6, the completion notice includes a Map complete description containing “a notification type, a JobID, a completed Map Task ID, and a slave ID that has performed the Map task”, and a Map complete description containing “a notification type, a JobID, a completed Map Task ID, a Reduce Task ID, and a data amount”.

The “notification type” stored in this example is information indicating whether the notification is a completion notice of a Map process or Reduce information, and, is set to “Map completed” in the case of the completion notice of a Map process and set to “Reduce data amount” in the case of the Reduce information. In the “JobID”, an identifier of a job to which the Map process belongs is set. In the “completed Map Task ID”, an identifier for identifying a completed Map process task is set. In the “slave ID that has performed the Map task”, an identifier of a slave server that has performed the Map process task and transmitted the completion notice is set. In the “Reduce Task ID”, an identifier for identifying a Reduce process task whose amount of data has been determined from an execution result of the Map process is set. In the “data amount (a unit is GB)”, the amount of data of the Reduce process task determined from the execution result of the Map process is set.

In the example in FIG. 6, a completion result of a Map process task of “Map135” in a job with the “JobID” of “Job013” is illustrated. The Map process task of “Map135” is a task performed by the slave server of “Node1”. Further, it is indicated, by the Map process task of “Map135”, that three Reduce processes of “Reduce131”, “Reduce132”, and “Reduce133” are present in the job with the “JobID” of “Job013”. Furthermore, it is indicated, by the Map process task of “Map135”, that the data amount of the Reduce process task of “Reduce131” is “1000”, the data amount of the Reduce process task of “Reduce132” is “1200”, and the data amount of the Reduce process task of “Reduce133” is “8000”.

The estimating unit 16 acquires the data amounts of the Reduce process tasks from the completion notice of the Map process task as described above, and adds the data amounts. Then, the estimating unit 16, when a result of the addition exceeds “10000”, estimates that a Reduce process with a large amount of processing data occurs.

Meanwhile, it is possible to set various triggers for the estimating unit 16 to estimate a sum of Reduce processes. Namely, it is possible to arbitrarily set how much of Map process tasks are completed when determination on whether the amount of processing data exceeds the threshold is to be performed.

For example, the estimating unit 16 may perform the determination at the completion of a predetermined percent of all of the Map process tasks. Further, the estimating unit 16 may perform the determination after a lapse of a predetermined time since completion of the first Map process task. Furthermore, the estimating unit 16 may perform the determination at earlier one of the above described two time points.

Incidentally, even the first Map process task may be specified at random. In this manner, it is possible to arbitrarily change a timing for estimation based on the number of the Map process tasks or the like, so that it is possible to perform customization by the input data.

The reassigning unit 17 is a processing unit that reassigns the slave server 30 to a Reduce process whose amount of processing is estimated as equal to or greater than the threshold by the estimating unit 16. Specifically, if the slave server 30 with low specifications is assigned to a Reduce process task with a large amount of processing by a hash function, the reassigning unit 17 reassigns the slave server 30 with high specifications to the Reduce process task.

For example, the reassigning unit 17 specifies the slave server 30 to which the notified Reduce process with a large amount of processing from the task list DB 12b, and specifies specifications of the specified slave server 30 from the cluster profile DB 12c. Then, the reassigning unit 17 determines whether the specified specifications meet the conditions such that “the CPU has three or more cores, a memory has 10 GB or more, and an HDD has 30 GB or more”. Incidentally, the conditions may be set and changed arbitrarily.

The reassigning unit 17, if the specifications of the assigned slave server meet the conditions, maintains the assignment performed by the hash function. In contrast, the reassigning unit 17, if the specifications of the assigned slave server do not meet the conditions, searches for the slave server 30 that meets the conditions among the slave servers 30 with the assignment state of “Not assigned” by referring to the cluster profile DB 12c. Then, the reassigning unit 17 changes the assignment state corresponding to the retrieved slave server 30 to “assigned”, and sets the slave ID of the detected slave server 30 in the “reassigned slave ID” of a corresponding Reduce process task. In this manner, the reassigning unit 17 reassigns the Reduce process task.

In the example in FIG. 4, the reassigning unit 17 receives, from the estimating unit 16, a notice indicating that the amounts of processing of the reduce process tasks of “Reduce001” and “Reduce002” are large. Then, the reassigning unit 17 determines that the specifications of the assigned Node2 and Node4 are low and reassignment is needed by referring to the cluster profile DB 12c. Subsequently, the reassigning unit 17 confirms that Node10 and Node11 with high specifications are not assigned by referring to the cluster profile DB 12c, and assigns the notified Reduce process tasks to these slave servers. In this example, the reassigning unit 17 reassigns Node11 to “Reduce001”, reassigns Node10 to “Reduce002”, and updates the task list DB 12b. In this case, the reassigning unit 17 assigns a task with a greater data amount to a server with higher specifications.

Incidentally, if the slave server 30 with “Not assigned” is absent, the reassigning unit 17 may change assignment so as to interchange a Reduce process, which is assigned to the slave server 30 in the state of “assigned”, and a Reduce process, which has a large amount of processing.

Configuration of Slave Server

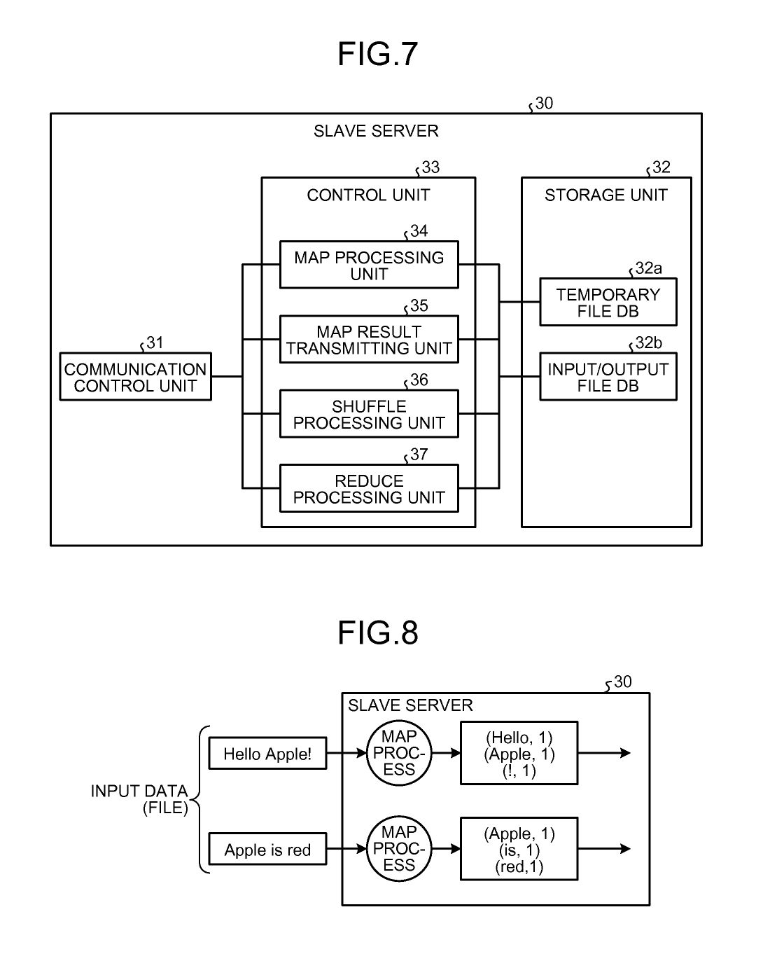

FIG. 7 is a functional block diagram illustrating a functional configuration of the slave server according to the second embodiment. As illustrated in FIG. 7, the slave server 30 includes a communication control unit 31, a storage unit 32, and a control unit 33.

The communication control unit 31 is a processing unit that performs communication with the master server 10, the other slave servers 30, or the like, and is, for example, a network interface card or the like. For example, the communication control unit 31 receives assignment of various tasks from the master server 10, and transmits completion notices of various tasks. Further, the communication control unit 31 receives data read from the corresponding slave server 30 in accordance with execution of various task processes.

The storage unit 32 is a storage device that stores therein a temporary file DB 32a and an input/output file DB 32b, and is, for example, a memory, a hard disk, or the like. Further, the storage unit 32 stores therein a computer program or the like to be executed by the control unit 33.

The temporary file DB 32a is a database for temporarily storing intermediate data generated in a Map process, a Shuffle process, a Reduce process, or the like, data read from the other slave servers 30 or the like, and data used by each processing unit at the execution of processes. The input/output file DB 32b is a database for storing input of a Map process and output of a Reduce process and used in cooperation with the input/output DB server 2.

The control unit 33 is a processing unit that controls the entire processing of the slave server, and is, for example, a processor or the like. The control unit 33 includes a Map processing unit 34, a Map result transmitting unit 35, a Shuffle processing unit 36, and a Reduce processing unit 37. Further, the Map processing unit 34, the Map result transmitting unit 35, the Shuffle processing unit 36, and the Reduce processing unit 37 are examples of electronic circuits or examples of processes executed by a processor.

The Map processing unit 34 is a processing unit that performs a Map process task. Specifically, the Map processing unit 34 requests the master server 10 to assign a Map process task by using a heartbeat. At this time, the Map processing unit 34 gives a notice of the number of empty slots of the slave server 30. Then, the Map processing unit 34 receives Map assignment information containing “a TaskID, a slave ID with data, the number of needed slots”, and the like from the master server 10.

Thereafter, if the slave server 30 specified by “the slave ID with data” is the slave server performing the process, the Map processing unit 34 acquires data from the input/output file DB 32b in accordance with the received Map assignment information. Otherwise, the Map processing unit 34 acquires data from the slave server 30 specified by “the slave ID with data”, stores the data in the temporary file DB 32a, and performs the Map process by using the same number of slots as specified by “the number of needed slots”. Then, the Map processing unit 34 stores a result of the Map process in the temporary file DB 32a or the like. The result of the Map process generated in this example contains, as illustrated in FIG. 6 for example, a task ID, a data amount, and the like of a Reduce process.

The Map result transmitting unit 35 is a processing unit that transmits the result of the Map process performed by the Map processing unit 34. For example, the Map result transmitting unit 35, when notified of completion of the Map process by the Map processing unit 34, reads a part of the result of the Map process from the temporary file DB 32a. Then, the Map result transmitting unit 35 generates a completion notice as illustrated in FIG. 6, and transmits the completion notice to the master server 10.

The Shuffle processing unit 36 is a processing unit that sorts the results of the Map processes by “Key”, merges “Key, Value” pairs containing the same “Key”, and generates processing objects of the Reduce process. Specifically, the Shuffle processing unit 36, when notified of completion of a Map process by the master server 10, acquires a result of a corresponding Map process from each of the slave servers 30 for preparation to perform a Reduce process of a job to which the Map process belongs. Then, the Shuffle processing unit 36 sorts the results of the Map processes by “Key” specified in advance, merges the processing results containing the same “Key”, and stores a result of the merge in the temporary file DB 32a.

For example, the Shuffle processing unit 36 receives, from the master server 10, completion of “Map000, Map001, Map002, and Map003” that are Map process tasks associated with the “JobID” of “Job001”, that is, a start of execution of Reduce process tasks associated with the “JobID” of “Job001”. Accordingly, the Shuffle processing unit 36 receives results of the Map processes from Node1, Node2, Node3, and Node4. Subsequently, the Shuffle processing unit 36 sorts and merges the results of the Map processes, and stores a result of the sort and the merge in the temporary file DB 32a or the like.

The Reduce processing unit 37 is a processing unit that receives a Reduce process task assigned by the master server 10, and performs the Reduce process task. For example, the Reduce processing unit 37 receives information on a Reduce process task configured with “a JobID, a TaskID, the number of needed slots, an amount of processing data” and the like. Then, the Reduce processing unit 37 stores the received information in the temporary file DB 32a or the like. Thereafter, the Reduce processing unit 37 acquires corresponding data from each of the slave servers 30, performs a Reduce process, and stores a result of the Reduce process in the input/output file DB 32b. Incidentally, the Reduce processing unit 37 may transmit the result of the Reduce process to the master server 10.

Explanation of Map Process

The Map process performed by the slave server 30 will be described below. FIG. 8 is a diagram for explaining the Map process. As illustrated in FIG. 8, the slave servers 30 receive “Hello Apple!” and “Apple is red” as pieces of input data, perform the Map processes on the respective pieces of the input data, and output “Key, Value” pairs.

In the example in FIG. 8, the slave server 30 performs the Map process on “Hello Apple!”, counts the number of elements of the input data, and outputs “Key, Value” pairs, in each of which an element is “Key” and a counting result is “Value”. Specifically, the slave server 30 generates “Hello, 1”, “Apple, 1”, and “!, 1” from the input data of “Hello Apple!”. Similarly, the slave server 30 generates “Apple, 1”, “is, 1”, and “red, 1” from the input data of “Apple is red”.

Shuffle Processing

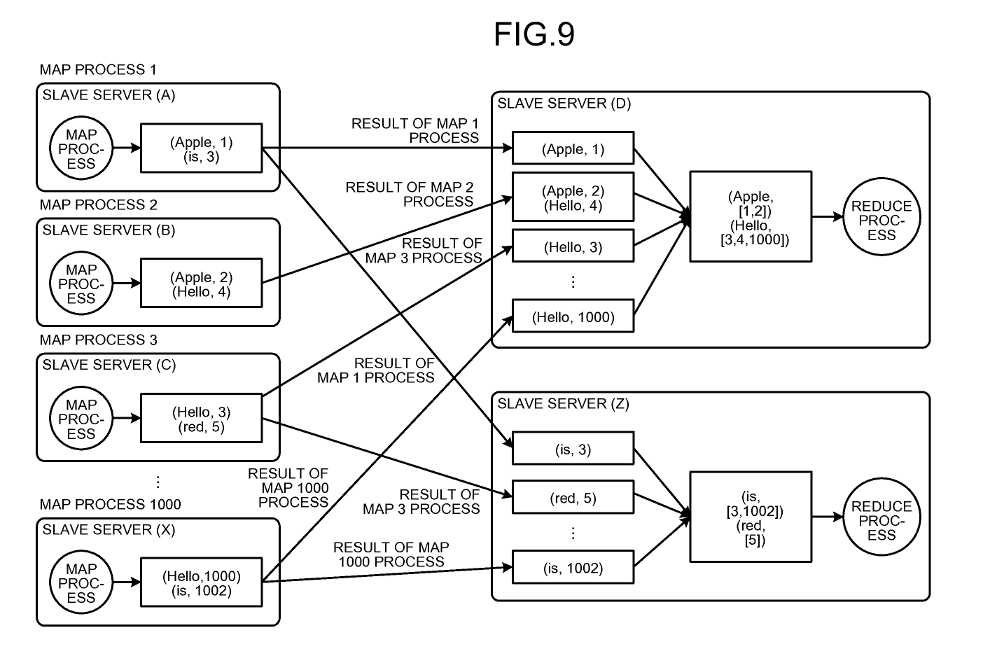

Next, the Shuffle process performed by the slave server 30 will be described. FIG. 9 is a diagram for explaining the Shuffle process. As illustrated in FIG. 9, each of the slave servers 30 acquires a result of a Map process from each of the slave servers and performs a Shuffle process.

In the example in FIG. 9, slave servers (A), (B), (C) . . . perform Map process tasks belonging to the same job (for example, JobID=20), and slave servers (D) and (Z) perform Reduce process tasks belonging to the job with the JobID=20.

For example, the slave server (A) performs a Map process 1 and generates “Apple, 1” and “is, 3”, the slave server (B) performs a Map process 2 and generates “Apple, 2” and “Hello, 4”, and the slave server (C) performs a Map process 3 and generates “Hello, 3” and “red, 5”. The slave server (X) performs a Map process 1000 and generates “Hello, 1000” and “is, 1002”.

Subsequently, the slave server (D) and the slave server (Z) acquire results of the Map processes of the respective slave servers for use in the assigned Reduce process tasks, and perform sort and merge. Specifically, it is assumed that a Reduce process task on “Apple” and “Hello” is assigned to the slave server (D), and a Reduce process task on “is” and “red” is assigned to the slave server (Z).

In this case, the slave server (D) acquires “Apple, 1” as a result of the Map process 1 from the slave server (A), and acquires “Apple, 2” and “Hello, 4” as a result of the Map process 2 from the slave server (B). Further, the slave server (D) acquires “Hello, 3” as a result of the Map process 3 from the slave server (C), and acquires “Hello, 1000” as a result of the Map process 1000 from the slave server (X). Then, the slave server (D) sorts and merges the results and generates “Apple, [1,2]” and “Hello, [3,4,1000]”.

Similarly, the slave server (Z) acquires “is, 3” as a result of the Map process 1 from the slave server (A), acquires “red, 5” as a result of the Map process 3 from the slave server (C), and acquires “is, 1002” as a result of the Map process 1000 from the slave server (X). Then, the slave server (Z) sorts and merges the results and generates “is, [3,1002]” and “red, [5]”.

Reduce Process

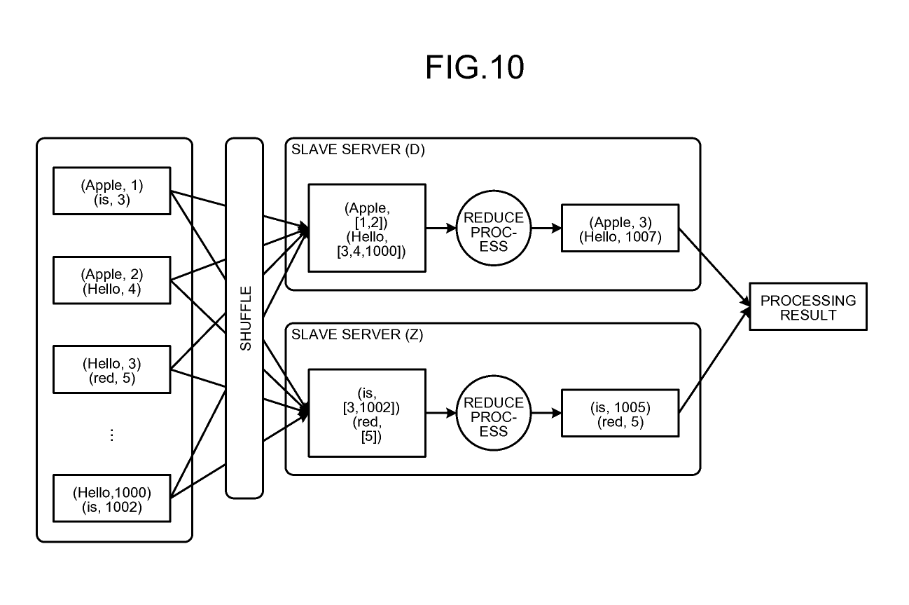

Next, the Reduce process performed by the slave server 30 will be described. FIG. 10 is a diagram for explaining the Reduce process. As illustrated in FIG. 10, each of the slave servers 30 performs a Reduce process by using a Shuffle result generated from a result of the Map process performed by each of the slave servers. Specifically, similarly to the explanation of the Shuffle process, it is assumed that a Reduce process task on “Apple” and “Hello” is assigned to the slave server (D) and a Reduce process task on “is” and “red” is assigned to the slave server (Z).

In this example, the slave server (D) cumulates values from “Apple, [1,2]” and “Hello, [3,4,1000]”, which are results of the Shuffle process, and generates “Apple, 3” and “Hello, 1007” as a result of the Reduce process. Similarly, the slave server (Z) cumulates values from “is, [3,1002]” and “red, [5]”, which are results of the Shuffle process, and generates “is, 1005” and “red, 5” as a result of the Reduce process.

Example of Change in Assignment

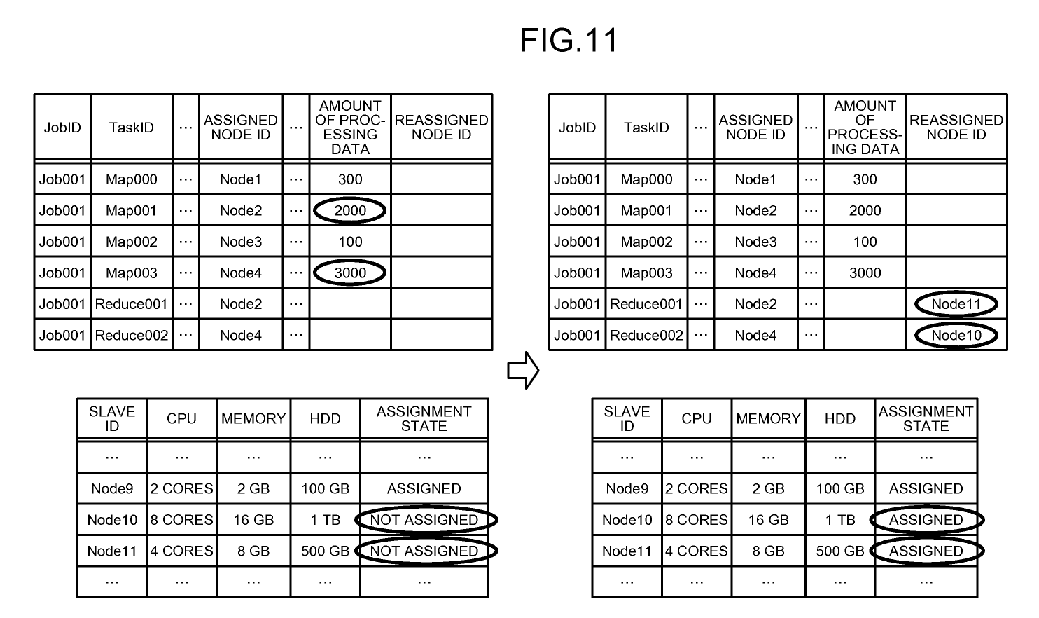

FIG. 11 is a diagram for explaining change in assignment of the Reduce process. In the example in FIG. 11, a Map process and a Reduce process related to a job with “Job001” will be described as one example; however, it is assumed that Map processes of other jobs or the like are also performed. Incidentally, it is assumed here that Node1 to Node4 are slave serves with low specifications.

As illustrated in the left side in FIG. 11, as for the Map process tasks, the master server 10 assigns “Map000” to Node1, “Map001” to Node2, “Map002” to Node3, and “Map003” to Node4 by using a hash function. Similarly, as for the Reduce process tasks, the master server 10 assigns “Reduce001” to Node2 and “Reduce002” to Node2 by using a hash function.

In this state, if the processes from “Map000” to “Map003” of the job of Job001 are completed while Map processes of jobs other than the job of Job001 are being performed, the master server 10 acquires an amount of processing data of each Map process task. At this time, the master server 10 detects that the amount of processing data of “Map001” is “2000 GB” that exceeds a threshold (1000 GB), and the amount of processing data of “Map003” is “3000 GB” that exceeds the threshold (1000 GB). Therefore, the master server 10 determines that the Reduce processes corresponding to the job of Job001 are reallocation targets.

Accordingly, the master server 10 specifies Node10 and Node11 as servers with the assignment states of “Not assigned” and with high specifications by referring to the cluster profile DB 12c. Then, as illustrated in the right side in FIG. 11, the master server 10 assigns the Reduce process of “Reduce001” corresponding to the job of Job001 to Node11 and assigns “Reduce002” to Node10.

Namely, the master server 10 changes the slave server 30 that performs “Reduce001” from Node2 assigned by the hash function to Node11. Similarly, the master server 10 changes the slave server 30 that performs “Reduce002” from Node4 assigned by the hash function to Node10. In this manner, the master server 10 reassigns the Reduce process task with a large amount of processing.

Process by Master Server

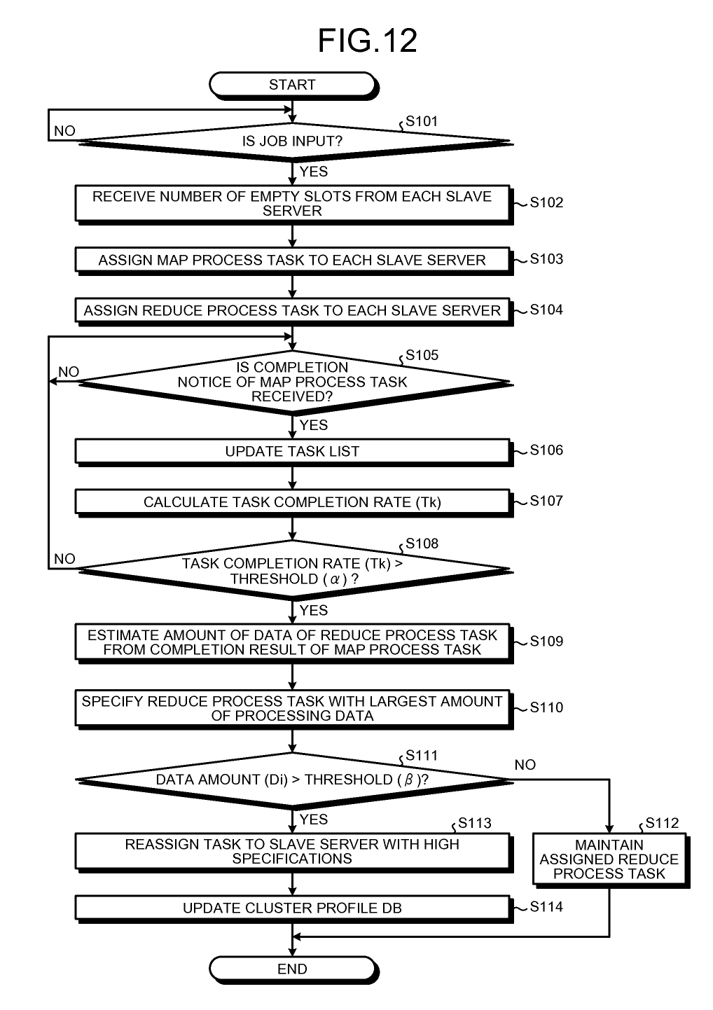

FIG. 12 is a flowchart illustrating the flow of a process performed by the master server according to the second embodiment. As illustrated in FIG. 12, the Map assigning unit 14 of the master server 10, upon input of a job (YES at S101), receives the number of empty slots from each of the slave servers (S102).

Then, the Map assigning unit 14 assigns a Map process task to each of the slave servers by using a hash function of a sort key specified in advance (S103). At this time, the Map assigning unit 14 updates the task list DB 12b in accordance with a result of the assignment.

Subsequently, the Reduce assigning unit 15 assigns a Reduce process task to each of the slave servers by using a hash function of a sort key specified in advance (S104). At this time, the Reduce assigning unit 15 updates the task list DB 12b and the cluster profile DB 12c in accordance with a result of the assignment.

Thereafter, the estimating unit 16, upon receiving a completion notice of the Map process task (YES at S105), updates the task list DB 12b (S106). Specifically, the estimating unit 16 changes the state of the Map process task whose process has been completed from “Running” to “Done”.

Subsequently, the estimating unit 16 calculates a task completion rate (Tk), which indicates how many Map process tasks are currently completed among all of the Map process tasks (S107), and determines whether the task completion rate (Tk) exceeds a threshold (α) (S108).

At this time, if the task completion rate (Tk) is equal to or lower than the threshold (α) (NO at S108), the estimating unit 16 returns to S105, waits for completion of a next Map process task, and repeats the subsequent processes. In contrast, if the task completion rate (Tk) exceeds the threshold (α) (YES at S108), the estimating unit 16 estimates the amount of processing data of each of the Reduce process tasks from a completion result of the finished Map process task (S109).

Then, the estimating unit 16 specifies a Reduce process task with the largest amount of processing data from the estimated amounts of processing data of the respective Reduce process tasks (5110). Subsequently, the estimating unit 16 determines whether an amount of processing data (Di) of the specified Reduce process task exceeds a threshold (β) (S111).

At this time, if the amount of processing data (Di) of the Reduce process task is lower than the threshold (β) (NO at S111), the estimating unit 16 maintains the Reduce process task as assigned by the hash function (S112). Specifically, the estimating unit 16 does not reassign the Reduce process task.

In contrast, if the amount of processing data (Di) of the Reduce process task exceeds the threshold (β) (YES at S111), the estimating unit 16 assigns a corresponding Reduce process task to a slave server with high specifications (S113). Then, the estimating unit 16 updates the cluster profile DB 12c and the task list DB 12b in accordance with a result of the assignment (S114). Namely, the estimating unit 16 reassigns the Reduce process task.

Process by Slave Server

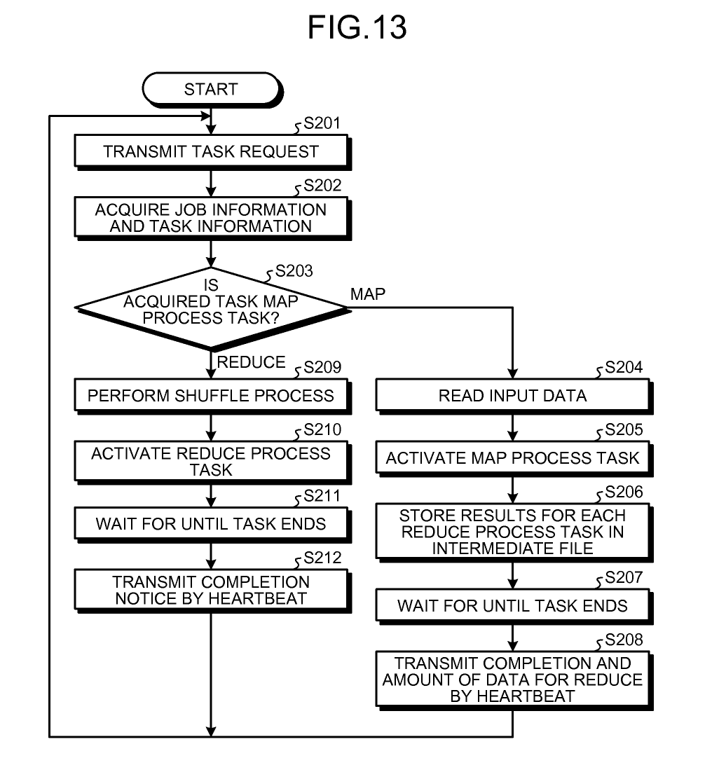

FIG. 13 is a flowchart illustrating the flow of a process performed by the slave server according to the second embodiment. As illustrated in FIG. 13, the slave server 30 transmits a task request by a heartbeat to the master server 10 (S201).

Subsequently, the slave server 30 acquires job information and task information as a reply to the request (S202), and determines whether the acquired task information is information on the Map process task (S203).

When it is determined that the acquired task information is the information on the Map process task (Map at S203), the Map processing unit 34 of the slave server 30 reads the input data (S204), and activates the Map process task (S205).

For example, the Map processing unit 34 acquires input data from the slave server 30 specified by the “slave ID with data” in the acquired information on the Map process task, and activates a Map process task assigned by the acquired information on the Map process task.

Thereafter, the Map processing unit 34 stores processing results for each Reduce process task in the temporary file DB 32a (S206), and waits for until the Map process task ends (S207). Then, the Map result transmitting unit 35 transmits a completion of the Map process task and an amount of data for Reduce to the master server 10 by using a heartbeat (S208).

In contrast, if it is determined that the task information acquired by the Reduce processing unit 37 is information on a Reduce process task (Reduce at S203), the Shuffle processing unit 36 acquires a result of the Map process from each of the slave servers 30, and performs a Shuffle process (S209).

The Reduce processing unit 37 performs the acquired Reduce process task (S210), waits for until the task ends (S211), and upon completion of the task, transmits a completion notice to the master server 10 by a heartbeat or the like (S212).

In this manner, the master server 10 monitors the progress state of the Map process, and estimates Reduce in which data may be concentrated, on the basis of completion results of some of the Map processes without waiting for completion of all of the Map processes. Then, if it is estimated that keys or data may be concentrated in the specific slave server 30, the master server 10 transfers the data to the slave server 30 with higher machine power to prevent concentration.

In general, if completion and transfer of the Map processes are waited for, data may be assigned to a Reduce process of the specific slave server 30 in a concentrated manner by a hash function. However, the master server 10, by estimating the amount of a Reduce process from results of some of the Map processes, prevents an increase in the amount of processing in the slave server with low specifications.

Namely, the master server 10, by employing a system that monitors the volume of an output result of the Map process beforehand, assigns a Reduce process with a large amount of processing to the slave server 30 with high machine power. As a result, it is possible to make the most of machine resources of the slave server 30, and reduce the entire processing time.

### [c] Third Embodiment

While the embodiments of the present invention have been described above, the present invention may be embodied in various forms other than the embodiments as described above. Therefore, the other embodiments of the present invention will be explained below.

Task Completion Rate

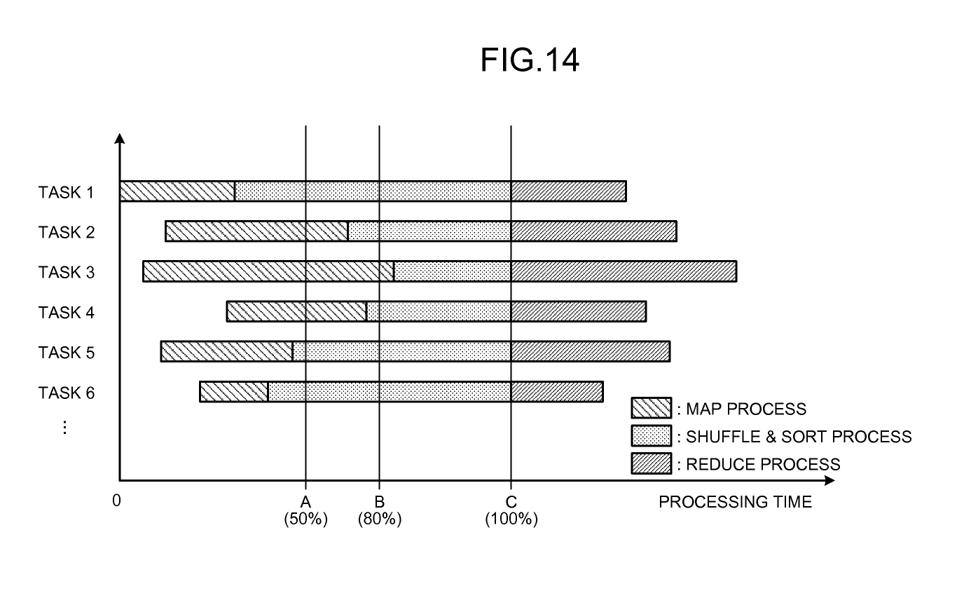

FIG. 14 is a diagram for explaining a relationship between a task progress image and a threshold. As illustrated in FIG. 14, MapReduce includes three phases of a Map process, a Shuffle and Sort process, and a Reduce process.

The Map process is performed at each timing on the assigned slave server 30. Similarly, the Shuffle and Sort process is performed at each timing on the assigned slave server 30. However, all of the slave servers 30 simultaneously start the Reduce processes after waiting for completion of all of the Map processes and all of the Shuffle and Sort processes. Namely, MapReduce divides a single job into a plurality of tasks and performs the tasks in parallel; therefore, a process of waiting for processes between the jobs in midstream is not needed unlike in a job net or the like, which is an advantage.

The master server 10 can arbitrarily set a degree of completion results of some of the Map process tasks. For example, in the example in FIG. 14, when completion of three tasks among six tasks are to be waited for (A), the task completion rate is 50%, and, when all of the Map process tasks are to be completed (C), the task completion rate is 100%.

The master server 10 increases estimation accuracy as the task completion rate approaches 100%; however, in this case, a timing to start reassignment may be delayed and a Reduce process may be started. In contrast, the master server 10 decreases estimation accuracy as the task completion rate approaches to 0%; however, a timing to start reassignment is advanced and reassignment can reliably be performed before the Reduce process. Therefore, the master server 10 can arbitrarily set a threshold of a task completion rate appropriate for a system, the number of jobs, and a job time, within a range from 0% to 100%.

Selection of Map Process Task

The master server 10 can employ an arbitrary method to select a Map process task to be used to estimate the amount of processing data of a Reduce process from among some of the completed Map process tasks. As one example, the master server 10 may select a predetermined number of Map process tasks in the order of completion. Further, the master server 10 may select a task at random from among completed tasks, or may select a task in the order calculated by a specific function or the like.

Further, the master server 10 may select a task in the order from the longest data transfer time. Specifically, the master server 10 calculates a time to transfer a result of a Map process, by using a communication speed between the slave servers and by using an amount of data of the Map process to be transferred. Further, the master server 10 may select a predetermined number of results of Map processes in the order from the longest transfer time.

Namely, the master server 10 calculates a data transfer time between the slave server that transfers the result of the Map process and the slave server that receives the result of the Map process, on the basis of a communication speed between the slave servers and an amount of data to be transferred, with respect to the results of the completed Map processes. Then, the master server 10 estimates the amount of processing data of a Reduce process by using a Map process task whose data transfer time is equal to or longer than a threshold.

Server Resources

In the second embodiment, an example has been described in which the master server 10 assigns a Reduce process with a large amount of processing to the slave server 30 with high specifications; however, the present invention is not limited thereto. For example, the master server 10 may assign a Reduce process with a large amount of processing to the slave server 30 with a large amount of available resources.

Specifically, the master server 10 periodically acquires a CPU use rate, a memory use rate, and a throughput of a hard disk from each of the slave servers 30 and calculates average values. Then, the master server 10 may select, as a destination of reassignment, the slave server 30 that has a large amount of resources at the estimated start time. Incidentally, the master server 10 may select, as a destination of reassignment, the slave server 30 that has a large amount of free resources at the estimated start time, instead of the average values.

Assignment

For example, when the number of slave servers with high specifications is greater than the number of Reduce processes with large amounts of data, the master server 10 may assign each of the Reduce processes to each of the slave servers, and assign even a Reduce process with a small amount of data to a slave server with high specifications. In contrast, when the number of slave servers with high specifications is smaller than the number of Reduce processes with large amounts of data, the master server 10 assigns each of Reduce processes with the largest amount of data to the slave servers with high specifications, and assigns the other Reduce processes to slave servers with low specifications.

System

Of the processes described in the embodiments, all or part of a process described as being performed automatically may also be performed manually. Alternatively, all or part of a process described as being performed manually may also be performed automatically by known methods. In addition, the processing procedures, control procedures, specific names, and information including various types of data and parameters illustrated in the above-described document and drawings may be arbitrarily changed unless otherwise specified.

The components of the apparatuses illustrated in the drawings are functionally conceptual and are not always physically configured in the manner illustrated in the drawings. In other words, specific forms of disintegration and integration of the apparatuses are not limited to those illustrated in the drawings. Namely, all or part of the apparatuses may be functionally or physically disintegrated or integrated in arbitrary units depending on various loads or use conditions. Further, for each processing function performed by each apparatus, all or any part of the processing function may be implemented by a CPU and a program analyzed and executed by the CPU or may be implemented as hardware by wired logic.

Hardware

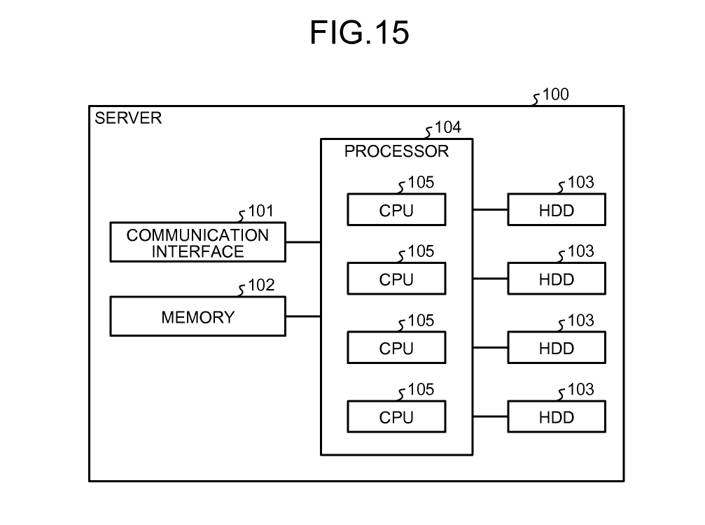

An example of a hardware configuration of each server will be described below. The servers have the same configurations, and therefore one example will be described below. FIG. 15 is a diagram illustrating an example of a hardware configuration of a server. As illustrated in FIG. 15, a server 100 includes a communication interface 101, a memory 102, a plurality of hard disk drives (HDDs) 103, and a processor 104.

The communication interface 101 corresponds to the communication control unit illustrated in FIG. 2 and FIG. 7, and is, for example, a network interface card or the like. The HDDs 103 store therein computer programs, DBs, and the like to implement the functions illustrated in FIG. 2 and FIG. 7.

A plurality of CPUs 105 included in the processor 104 read computer programs that execute the same processes as those of the processing units illustrated in FIG. 2 or FIG. 7 from the HDDs 103 or the like, and load the computer programs on the memory 102, thereby implementing the functions described with reference to FIG. 2 and FIG. 7. Namely, the processes implement the same functions as those of the Map assigning unit 14, the Reduce assigning unit 15, the estimating unit 16, and the reassigning unit 17 of the master server 10. Further, the processes implement the same functions as those of the Map processing unit 34, the Map result transmitting unit 35, the Shuffle processing unit 36, and the Reduce processing unit 37 of the slave server 30.

As described above, the server 100 operates as an information processing apparatus that implements a task assignment method or a task execution method by reading and executing the computer programs. Further, the server 100 may implement the same functions as described in the embodiment by causing a medium reading device to read the computer programs from a recording medium and executes the read computer programs. Incidentally, the computer programs described in the other embodiments are not limited to those executed by the server 100. For example, the present invention may be applied, in a similar manner, to a case where other computers or servers execute the computer programs or the other computers and the servers execute the computer programs in cooperation with one another.

According to an embodiment of the present invention, it is possible to reduce a completion time of the entire job.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A non-transitory computer-readable recording medium having stored therein a task assignment program that causes a computer to execute a process comprising:
distributing pieces of divided data contained in a first divided data group, which is obtained by dividing input data, to a plurality of nodes that execute Map processes;
estimating, upon completion of Map processes of partial divided data groups in the first divided data group, a data amount of each piece of distributed data by applying, to results of the Map processes of the partial divided data groups, a generation rule for generating pieces of the distributed data for a plurality of nodes that execute Reduce processes which are executed after completion of all of Map processes on the first divided data group; and
starting to control selection of nodes, to which at least some pieces of the distributed data are assigned, on the basis of the estimated data amounts before completion of all of the Map processes on the first divided data group.

2. The recording medium according to claim 1, wherein
the estimating includes selecting a predetermined number of results of Map processes in order from completion from among completed Map processes, and estimating the data amount of each piece of the distributed data on the basis of the predetermined number of the selected results of the Map processes.

3. The recording medium according to claim 1, wherein
the estimating includes selecting a predetermined number of results of Map processes in order form a longest transfer time of each piece of the distributed data on the basis of a communication speed between the nodes and the estimated data amounts, and estimating the data amount of each piece of the distributed data on the basis of the predetermined number of the selected results of the Map processes.

4. The recording medium according to claim 1 wherein
the starting includes assigning a piece of the distributed data whose data amount exceeds a threshold among the estimated data amounts to a node whose hardware specification that is specified from at least one of the number of processors, a memory capacity, and a hard disk capacity exceeds a threshold among the nodes.

5. The recording medium according to claim 1, wherein
the starting includes assigning a piece of the distributed data whose data amount exceeds a threshold among the estimated data amounts to a node whose amount of free resources specified from at least one of the number of processors, a memory capacity, and a hard disk capacity exceeds a threshold among the nodes.

6. A task assignment method comprising:
distributing pieces of divided data contained in a first divided data group, which is obtained by dividing input data, to a plurality of nodes that execute Map processes, using a processor;
estimating, upon completion of Map processes of partial divided data groups in the first divided data group, a data amount of each piece of distributed data by applying, to results of the Map processes of the partial divided data groups, a generation rule for generating pieces of the distributed data for a plurality of nodes that execute Reduce processes which are executed after completion of all of Map processes on the first divided data group, using a processor; and
starting to control selection of nodes, to which at least some pieces of the distributed data are assigned, on the basis of the estimated data amounts before completion of all of the Map processes on the first divided data group, using a processor.

7. A task assignment apparatus comprising:
a processor that executes a process including:
distributing pieces of divided data contained in a first divided data group, which is obtained by dividing input data, to a plurality of nodes that execute Map processes;
estimating, upon completion of Map processes of partial divided data groups in the first divided data group, a data amount of each piece of distributed data by applying, to results of the Map processes of the partial divided data groups, a generation rule for generating pieces of the distributed data for a plurality of nodes that execute Reduce processes which are executed after completion of all of Map processes on the first divided data group; and
starting to control selection of nodes, to which at least some pieces of the distributed data are assigned, on the basis of the estimated data amounts before completion of all of the Map processes on the first divided data group.
